(19) United States
(12) Patent Application Publication
(10) Pub. No.: US 2016/0321395 A1
(43) Pub. Date: Nov. 3, 2016

(54) SYSTEM AND METHOD FOR REAL-TIME PERSONALIZATION UTILIZING AN INDIVIDUAL'S GENOMIC DATA

(71) Applicant: Sequencing.Com, Southlake, TX (US)

(72) Inventors: Brandon Colby, Los Angeles, CA (US); Ashwin Kotwaliwale, Southlake, TX (US)

(73) Assignee: SEQUENCING.COM, Southlake, TX (US)

(21) Appl. No.: 15/102,395

(22) PCT Filed: Dec. 8, 2014
(86) PCT No.: PCT/US14/69168

§ 371 Date: Jun. 7, 2016

Related U.S. Application Data
(60) Provisional application No. 61/913,287, filed on Dec. 7, 2013.

(51) Int. Cl. G06F 19/18; G06Q 30/02; G06F 19/28

(52) U.S. Cl. CPC G06F 19/18; G06F 19/28; G06Q 30/0241

(57) ABSTRACT

The principles of the present invention provide methods and systems for processing personal biological data for real time or near real time application. An exemplary system includes a received reference genome and a received personal genome. The genomes are accessed over a network by one or more servers. Input from one or more sensors associated with an individual or remote from the individual is used in conjunction with the individual's genomic data or the results of the comparison of the individual's genetic data and the reference genome(s) to provide real-time or near real-time suggestions, recommendations, warnings and the like in view of the sensor data and genomic data. An exemplary method includes receiving the personal genome and optionally selecting a suitable reference genome. The system compares the personal genome to the reference genome, of parts thereof, for one or more selected genotype(s) and/or phenotype(s) corresponding to a condition of concern in order to determine the differences between the reference genome and the personal genome. A sensor corresponding either directly or indirectly to the selected condition of concern is selected and optimum values for the sensor are calculated. The sensor is placed in proximity with the individual and the output is monitored. Alerts and reporting are presented in response to the sensor output. The present invention concerns systems and methods for analysis of biological data and integration of such data into everyday life.

### PRIORITY

This application claims priority to U.S. Provisional Patent Application No. 61/913,287 filed Dec. 7, 2013 entitled “System and Method for Integrating Genetic Information Into Daily Life” the contents of which are expressly incorporated herein by reference.

### BACKGROUND

1. Field of the Invention

The present invention relates generally to the field of analysis of personal biological information, more specifically analysis and application of personal biological information.

2. Description of Related Art

The genetic profile of a person can provide substantial information about a number of personal characteristics, referred to as phenotypes. A phenotype is any observable or measurable characteristic or trait. For example, a phenotype may be a trait such as hair color, an adverse reaction to a medication or a disease such cardiovascular disease. Substantial efforts to reduce the cost of sequencing DNA have been quite successful; investigators are now faced with massive data management, data analysis, and data interpretation challenges. Even after genotype to phenotype interpretation has occurred, there remain challenges in application of the resulting data and information. It would be useful for additional systems and methods for managing and analyzing an individual's biological information, such as genetic information, as well as utilizing this information such as systems and methods to apply the personalized results.

### SUMMARY

The principles of the present invention provide methods and systems for processing personal biological data for real time or near time decision making. Exemplary embodiments of the present invention provide a system for storage and analysis of biological information. An exemplary system includes a received reference genome and a received personal genome. The genomes are accessed over a network by one or more servers. One or more sensors associated with an individual are in communication with an individual's personal computer, which, in turn, is in communication with the server(s). An exemplary method of employing the system includes receiving the personal genome and selecting a suitable reference genome. The system compares the personal genome to the reference genome, of parts thereof, for one or more selected genotype(s) and/or phenotype(s). The system then uses genetic data to interpret one or more phenotypes of concern. A sensor that measures a non-genetic factor associated either directly or indirectly to the selected phenotype of concern is selected and optimum values for the sensor are calculated. The sensor is placed in proximity with the individual, or the sensor may be placed anywhere in the world and allowed to communicate with another electronic device controlled by the individual or representative for the individual, and the output is monitored. Alerts and reporting are presented in response to the sensor output.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 is a diagram depicting an embodiment of the system according to the current invention;

FIG. 2 is a diagram depicting embodiments of systems according to the current invention as it may exist in operation;

FIG. 3 is a flowchart depicting a method deployed to systems of the current invention;

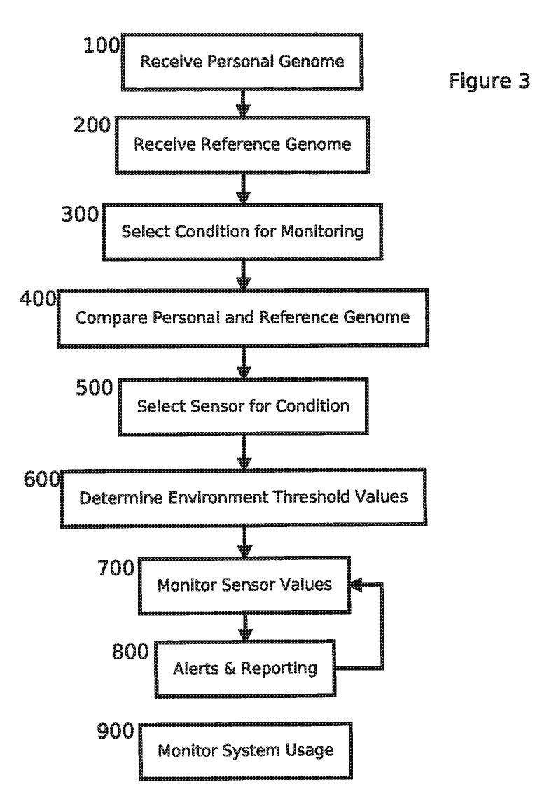

FIG. 4 is a diagram depicting a system architecture of an embodiment according to the current invention;

FIG. 5 is a diagram depicting a subsystem architecture of an embodiment according to the current invention;

FIG. 6 is a diagram depicting a system architecture of an embodiment according to the current invention;

FIG. 7 is a diagram depicting a representative set of modules for an environment and representative partial grouping of the modules;

FIG. 8 is a flowchart depicting usage of an embodiment of a system according to the current invention;

FIG. 9 is a diagram depicting usage of an embodiment of a system according to the current invention; and

FIG. 10 is a diagram depicting usage of an embodiment of a system according to the current invention.

FIG. 11 is a diagram depicting usage of an embodiment of a system according to the current invention.

### DESCRIPTION

Principles of the present disclosure also include a non-transitory computer program product for analysis of biological data, the computer program product being embodied in a computer readable storage medium and comprising computer instructions for storing a database comprising biological data from a plurality of subjects obtained from at least a first and a second source, storing a plurality of software applications for performing a plurality of different analyses of biological data, and providing access to a user to at least a first of said software applications.

Principles of the present disclosure also include a system for managing a plurality of different personal analysis services, the system comprising one or more processors configured to store and/or access a database comprising biological data from a plurality of subjects obtained from at least a first and second source, store a plurality of software applications for performing a plurality of different analyses of biological data, provide access to a user to at least a first of said software applications, and a memory coupled to the one or more processors, configured to provide the processor with instructions.

Principles of the present disclosure also include a non-transitory computer program product for analysis of genetic data, the computer program product being embodied in a computer readable storage medium and comprising computer instructions for storing and/or accessing a database comprising a male reference genome and a female reference genome, storing a plurality of software applications for performing a plurality of different analyses of genetic data, providing access to a user to at least a first of said software applications. In some embodiments, it is understood that one or more of the genomes may be stored remote from the analysis system. Moreover, in some embodiments, there is no need to perform a comparison or analysis between reference genome(s) and an individual's genome as the input genetic information already contains an identification of the variants between an individual's genome and one or more reference genomes.

Principles of the present disclosure also include a system for managing a plurality of different personal analysis services, the system comprising one or more processors configured to store and/or access a database comprising a male reference genome and a female reference genome, store a plurality of software applications for performing a plurality of different analyses of genetic data, provide access to a user to at least a first of said software applications, a memory coupled to the one or more processors, configured to provide the processor with instructions.

It is contemplated that any embodiment of a method or composition described herein can be implemented with respect to any other method or composition described herein.

The use of the word “a” or “an” when used in conjunction with the term “comprising” in the claims and/or the specification may mean “one,” but it is also consistent with the meaning of “one or more,” “at least one,” and “one or more than one.”

The use of the term “or” in the claims is used to mean “and/or” unless explicitly indicated to refer to alternatives only or the alternative are mutually exclusive, although the disclosure supports a definition that refers to only alternatives and “and/or.”

Throughout this application, the term “about” is used to indicate that a value includes the standard deviation of error for the device or method being employed to determine the value. As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description. Various example embodiments of the present invention are discussed in detail below with reference to the accompanying drawings, in which example embodiments of the present invention are shown. While specific implementations are discussed, this is done for illustration purposes only. A person of ordinary skill in the relevant art will recognize that other components and configurations maybe used without departing from the spirit and scope the present invention. Like numbers refer to like elements throughout.

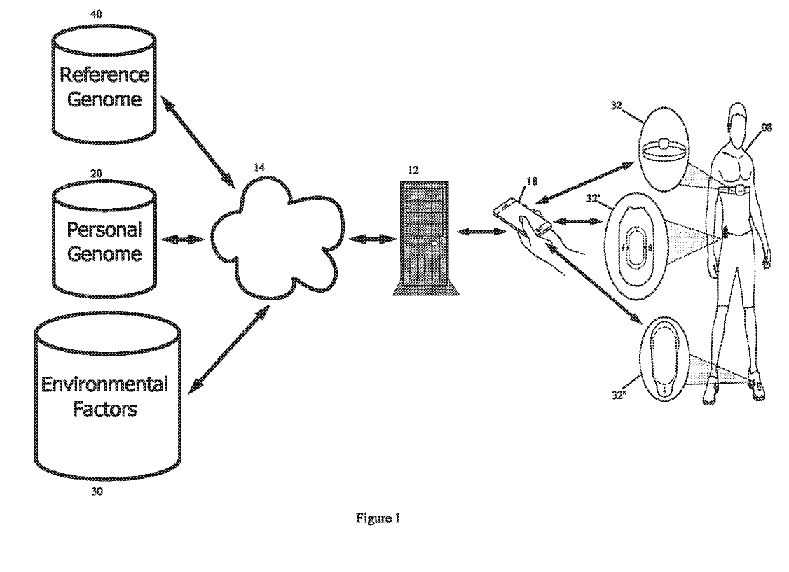

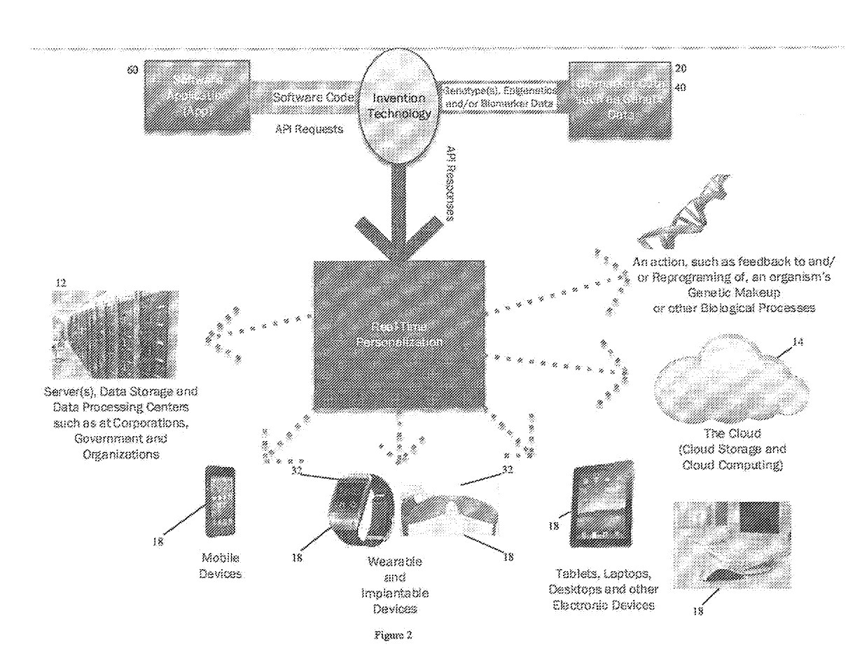

Biological information can provide insight into numerous facets of an individual's life and when the individual or a person related to the individual, such as the individual's parent or healthcare provider, is informed of the individual's biological make-up, this information should contribute to better or more informed decision-making. However, as of yet, researchers and caregivers have managed the information surrounding these biological or genetic features, as the majority of the efforts have been to identify genetic factors contributing to disease. It is difficult for the individual to make real time or near real time decisions based on their personal genetic makeup. Here, however, the principles of the present invention provide methods and systems for processing personal biological data for real time or near time decision making. Exemplary embodiments of the present invention provide a system for storage and/or analysis of biological information. FIG. 1 illustrates an embodiment of a system of the current invention while FIG. 2 illustrates embodiments of systems as they may exist in operation. Illustrated are a reference genome 40, a personal genome 20, and environmental factors 30 which are accessed over a network 14 by a server 12. Sensors 32 associated with an individual 08 are in communication with the individual's personal computer 18, which, in turn, is in communication with the server 12.

As used in this specification, genome indicates the genetic data of an individual. The term genome is used herein to refer to a single allele, a single genotype, multiple genotypes or the entire genetic makeup of an individual (approximately three billion genotypes). Genetic data may be from nuclear DNA, mitochondrial DNA, fetal DNA circulating in maternal blood, fetal cells circulating in maternal blood, somatic cells, germline cells, tumor cells and/or from microorganisms or other organisms.

The reference genome 40 and personal genome 20 are databases for storage of biological information for one or more individuals 08. As used herein, biological information include genetic and related information. For instance, biological information can include genomic sequence, cDNA sequence, mRNA, sequence and/or expression profiles, epigenetic data, proteomic data, exome data, methylation data, metabolome data, microbiome data, mitochondrial sequence data, genotypic data from PCR, genotypic data from DNA microarrays, genotypic data from whole genome sequencing, genotypic data from Exome sequencing, genotypic data from gene sequencing, karyotype data, pre-implantation genetic testing data, non-invasive prenatal genetic testing of embryo and/or fetus. Such data can be obtained by methods that are well known in the art.

The reference genome 40 and personal genome 20 can be retrieved or derived from various sources. In an embodiment when nucleotide sequence is desired, it may be obtained by methods such as de novo sequencing of genomic DNA, or transfer of genetic information from a third party, such as NCBI databases (including but not limited to GenBank and Entrez) or other public or private databases, such as those that are owned and/or controlled by DNA Data Bank of Japan (National Institute of Genetics), European Nucleotide Archive (European Bioinformatics Institute), Ensembl, UniProt, Swiss-Prot, Proteomics Identifications Database, Protein DataBank in Europe, Protein DataBank in Japan, BIND Biomolecular Interaction Network Database, Reactome, mGen, PathogenPortal, SOURCE, MetaBase, BioGraph, Bioinformatic Harvester, Enzyme Portal, Max Planck Institute, Illumina including but not limited to Illumina's laboratories and/or BASESPACE, Life Technologies, Complete Genomics, Pacific Biosciences, Affymetrix, Agilent, Sequenom, Arrayit Corporation, Laboratory Corporation of America, Quest Diagnostics, Empire Genomics, Expression Analysis, GeneDx, Gene by Gene, Natera, Ambry Genetics, National Geographic, Coriell Institute for Medical Research, Kaiser Permanente, governmental databases, a researcher's databases, a university's databases, a laboratory's databases, a laboratory's genetic testing equipment, a device that conducts genetic testing including but not limited to desktop sequencers and/or a lab-on-a-chip, a medical institution's databases, a healthcare-related databases, a health insurance company's database, a private company's databases, a public company's databases, BioPhysical Corporation, Spectracell Laboratories, Health Diagnostic Laboratory Inc., Knome, Counsyl, Ancestry.com, Family Tree DNA, Match.com, eHarmony, okCupid, Drugs.com, HGMD Human Gene Mutation Database, OMIM Online Mendelian Inheritance in Man, SNPedia, Wikipedia, Facebook, Myspace, LinkedIn, Google (including but not limited to internet search history, click through history, and Google Plus databases), Amazon, Apple, Yahoo!, Instagram, Pinterest, Twitter, European Molecular Biology Laboratory, Asia Pacific Bioinformatics Network, Beijing Genomics Institute, Healthcare.gov, United States Department of Health and Human Services, The Centers for Medicare and Medicaid Services, United States Veterans Affairs, Calico, DNA Nexus, Pathway Genomics, i-gene, an individual's personal computer, an individual's phone, an individual's tablet device, an individual's electronic device, Genotek, bio-logis, Genelex, Lumigenix, Spiral Genetics, a healthcare provider's database, electronic medical records, electronic health records, Xcode Life Sciences, Riken Genesis, Personalis, MapMyGenome, and/or 23andMe.

The reference genome 40 and personal genome 20 are stored in a file format which facilitates ready access. The genetic data may be stored and/or made accessible as raw data files, such as BAM and FASTQ files, data files in-which genotypic calls have been made, such as VCF and/or txt and/or xls or xlsx files, or it may be stored as information following tertiary analysis or other post-processing, such as if it is stored as phenotypic information. The genetic data may be stored in databases, memory, and/or frameworks for distributed processing such as Hadoop.

It is within the scope of this invention to employ different genetic datasets. A genetic dataset may be referred to as being reference data if several genetic analysis algorithms access and/or make use of that dataset. A reference genome 40 may include genetic datasets of individuals who may be defined by one or more criteria, such as genotype, haplotype, demographics, sex, nationality, age, ethnicity, first-degree relatives, first and second-degree relatives, or other groupings. These are genetic datasets that may be available to the public or to a specific community or organization.

This invention may employ available genetic datasets or create custom reference datasets such as a Free of Detrimental Variants (Free) reference dataset for a female (FreeWoman) and/or for a male (FreeMan). As an example, the FreeMan reference genetic dataset may be a single male genome and/or a genotypic file for a part or for the entire genome of a male, such as a VCF file. The FreeMan reference dataset may not contain any genetic variations that are known to cause a dominant monogenic disease such as Malignant Hyperthermia and/or any genetic variations that increase the risk of a polygenic and/or multifactorial disease such as melanoma. The FreeMan reference genetic dataset may also not have any genetic variations that cause rare diseases such as Epidermolysis Bullosa Simplex. The FreeMan reference genetic dataset may also have all of the genetic variations that are known to provide protection against (lower risk) of disease, such as the APOE2/APOE2 genotype that is associated with a substantially lower risk of Alzheimer's disease and may be associated with a lower risk of Cardiovascular Disease. The FreeMan and/or FreeWoman reference datasets may facilitate, such as by speeding up, lowering cost or enabling new forms of genetic research and/or genetic testing and/or genetic analysis. The FreeMan and FreeWoman reference datasets may also be valuable to genetic testing companies such as Illumina, Pacific Biosciences and Complete Genomics as well as Personal Genomics companies such as Knome, 23andMe and Pathway Genomics.

In some instances, FreeMan and or FreeWoman may be ethnicity and/or population specific so that there may be a FreeMan-Han Chinese and a FreeMan-Caucasian. The ethnicity and/or population specific FreeMan reference datasets and FreeWoman reference datasets may contain different data. FreeMan and FreeWoman reference datasets may also be created based upon other predefined parameters, such as FreeMan-Centenarian and/or FreeWoman-Centenarian, which are reference datasets that are the most likely genotypes throughout a genome or at specific genes within a genome for men and/or women that live to 100 years old and older.

In another instance, a reference genome 40 may be achieved by allowing the genotypes of a woman and/or the genotypes of a man for the reference dataset to be modified by the public so that the outcomes, which may be referred to as WikiWoman and WikiMan, are based upon crowd sourcing.

In another instance, a reference genome 40 may be a celebrity genome, such as the genome of a famous actor, actress, athlete, singer, performer, comedian, hero, champion at an event, or politicians. Any of these custom reference datasets may also be used as sample genetic data when using applications and/or application sequencing that can use and/or store genetic data.

It is known that a genome is the basis of determining certain phenotypes, such as traits, characteristics, disorders, diseases, conditions and the body's response to substances such as medications and toxins. Some phenotypes are determined solely by a genome while other phenotypes are determined through a combination of a genome with non-genetic factors, such as the environment. Recent advances have enabled detection of conditions based on genome sequence and comparison. More than 5,000 monogenic, polygenic, and multifactorial phenotypic based diseases, disorders, trait, characteristics, and pharmacogenomics are identifiable in a genome. Representative conditions include, but are not limited to, likelihood of male pattern baldness, likelihood of developing skin cancer, Alzheimer's risk and Alzheimer's prevention, ways to protect offspring from Alzheimer's, melanoma risk and melanoma prevention, heart attack risk and heart attack prevention, osteoarthritis risk and osteoarthritis prevention, sudden death risk such as due to cardiac arrhythmias and sudden death prevention, a comprehensive rare disease screen that assesses whether a person is likely to be affected by, a carrier of, or not affected and not a carrier of, from one to more than 5,000 monogenic diseases, athletic performance optimization, genetically tailored vitamins and supplements, weight loss optimization, lactose tolerance detection, predisposition to sudden infant death syndrome, predisposition to childhood learning disorders such as dyslexia, risk of autism, and deficient detoxification pathways.

In exemplary configuration, the reference genome 40 is indexed by one or more factors, such as genotype, haplotype, demographics, sex, nationality, age, ethnicity, or other factors for retrieval, analysis, comparison, and other processing.

The personal genome 20 includes the genetic data for one individual 08. The Genetic data may be in the form of a single genetic testing result, such as a single genotype, to an organism's entire genome and/or epigenome. A single Whole Genome Sequencing (WGS) genetic test (also referred to as sequencing an individual's whole genome) provides all or almost all of the genotypic sequence of an individual, which is then stored as electronic files, such as in FASTQ, BAM, SAM and/or VCF format. These files then contain practically all of the genotypes (genotypic data) for that individual. If direct genetic data is not available for an individual, then calculated and/or likely and/or hypothetical genetic data of individual based of analysis of genetic data from relatives and/or individuals with specific similarities may also be used.

The environmental factors 30 are non-genetic factors, those factors that may have an impact upon a phenotype. Examples of non-genetic factors are a person's diet, exercise, habits such as smoking and/or drinking, pharmaceuticals, geography where a person grew up or lives, amount of sleep a person has a night, stress, and anything else that is not genetic but still may have an impact in some way upon one or more phenotypes.

The reference genome 40, personal genome 20, and environmental factors 30 may be retrieved over a network 14. The network 14 includes a variety of network components and protocols known in the art which enable computers to communicate. The computer network 30 may be a local area network or wide area network such as the internet.

A server 12 or personal computer 18 executes instructions of the current invention. A server 12 or personal computer of the present invention includes a portable computing device, such as a smart phone, a personal digital assistant (PDA), a tablet computer, a wearable computer including but not limited to a watch and/or glasses, an implantable computer such as a pacemaker or other implanted electronic device, or a standard computing device, such as a desktop computer or laptop computer. This is not to be construed as limiting, as the present invention maybe applicable to any electronic network accessible to a user via a network-appropriate device. The system will include any necessary servers, computers, memory and the like. The system can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. The system may also function, in part or in whole, in the cloud (i.e. via cloud computing). In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term processor refers to one or more devices, circuits, and/or processing cores configured to process data, such as computer program instructions.

One or more sensors 32 are incorporated in this embodiment to directly or indirectly measure Measurable Non-Genetic Factors (“MNGF”s), also referred to as conditions in this specification, that are associated with one or more genotypes or phenotypes that have been interpreted in-part or in-whole from the personal genome 20 of an individual 08. The MNGF can be any non-genetic factor that can be measured by a sensor such as a heart rate, trajectory, speed of movement, skin temperature, sleep patterns such as REM and non-REM cycles, GPS location, and any other non-genetic factor that can be measured. The MNGF may be associated directly or indirectly with a genotype or phenotype that have been interpreted in-part or in-whole from a personal genome. For example, a MNGF for phenotype X may measure the actual phenotype X, a marker for the phenotype X, a prevention for the phenotype X, a specific factor, such as an activity, that is related to the prevention of a phenotype X, a factor, such as an activity, that is related to increasing the risk of a phenotype X, or any non-genetic measurable factor that can be related directly or indirectly in any way to phenotype X. For example, a MNGF for the phenotype diabetes mellitus type II may be blood glucose level as this is directly associated with the phenotype or it may be number of steps a person takes a day as this is indirectly associated with the phenotype (because number of steps taken per day can indicate a person's activity level and a low daily activity level can predispose to the phenotype while a higher than average activity level may help lower the risk of the phenotype).

The sensor 32 can be implanted, wearable, or a device in continuous proximity to the individual such as a smartphone 18. Alternatively, the sensor may not be in continuous proximity with the individual, such as a sensor located in a store, office, street, arena, home or any other public or private place that determines whether an individual is within a certain range from the sensor, communicates or obtains information from the individual's device (such as by Near Field Communication (NFC), Bluetooth, WiFi or other similar device-to-device communications) and/or measures biometric data about the individual. The sensor may be located anywhere in the world and it may communicate either continuously or intermittently with an individual's device such as through an application programming interface, NFC, Bluetooth, WiFi or other similar method. A suitable sensor 32 is one which directly or indirectly measures a Measurable Non-Genetic Factor (“MNGF”) that is associated with one or more genotypes and/or phenotypes that have been interpreted in-part or in-whole from a personal genome 20. For example, the nonexclusive listing of phenotypes that can be interpreted in-part or in-whole from a personal genome previously disclosed included predisposition to heart arrhythmia. One suitable sensor 32 for directly monitoring a MNGF associated with a heart arrhythmia is a heart rate sensor 32. Another disclosed phenotype is obesity. One suitable sensor 32 for indirectly monitoring an individual's physical activity is an accelerometer 32 that can determine whether an individual is sitting, walking, biking, taking stairs, taking an elevator or driving in a car. More disclosure of sensors 32 is below in the examples.

FIG. 2 illustrates a process of the current invention. At step 100, the system receives a personal genome 20. At step 200, the system receives a reference genome 40. At step 300, a condition for monitoring is selected. At step 400, the system compares the personal genome 20 to the reference genome 30. At step 500, a sensor 32 corresponding to the selected condition is selected. At step 600, optimum values for the sensor 32 are calculated. At step 700, the sensor 32 output is monitored 700. At step 800, the alerts and reporting are presented. More consideration will be given to each of the steps below.

At step 100, the system receives the personal genome 20, or part thereof, of the individual 08. As disclosed above, the individual may have the results of a single whole genome sequencing genetic test as electronic files, such as in FASTQ, BAM, SAM and/or VCF format. In this configuration, the personal genome 20 is uploaded to the system or made accessible to the system, such as through an application programming interface (API).

In another configuration, the personal genome 20 is uploaded by, or made accessible from, third parties such as laboratories (such as LabCorp, Quest, and/or any other testing laboratory), academic centers, hospitals, healthcare provider's offices, companies (such as Illumina, Sequenom, Roche/454 Life Sciences, 23andMe, Ancestry.com, Counsyl and Knome), organizations (such as research organizations and non-profits established to help people avoid or treat a specific disease), governmental agencies, governments or other entities that may have access to more than one person's genetic information.

In yet another embodiment, a user of the system disclosed herein requests the transfer of their biological or genetic data from the third party to the open system of the present invention. This may be accomplished by any method but generally will be accomplished via electronic communication of instructions to the third party storage system to initiate the transfer of data to the system disclosed herein. Transfer may include moving or copying the genetic data to the system disclosed herein or it may include making the genetic data accessible to the system disclosed herein, such as through an application programming interface.

If a compete personal genome 20 is unavailable for an individual, then calculated and/or likely and/or hypothetical genetic data of individual based of analysis of genetic data from relatives and/or individuals and/or research studies with specific similarities may also be employed.

At step 200, the system receives a reference genome 40 or receives access to a reference genome 40. As disclosed above, a reference genome can include genetic datasets of varying genotype, haplotype, demographics, sex, nationality, age, ethnicity, relatives, select individual, or other groupings. The desired genetic dataset is selected. Raw data files, such as FASTQ, BAM, SAM, VCF, or XLS files for the desired dataset are received.

At step 300, one or more MNGF(s) associated with phenotypes are selected for monitoring. The phenotype can be monitoring for development of another phenotype or can help inform decisions on the type and/or degree of response a person with a particular genetic profile may have to a specific substance or environmental factor. For example, this may include recommending or indicating the most effective suntan lotion for an individual, the skin care products most likely to be effective and/or least likely to cause an adverse reaction, the most effective medicine to treat a disease, and/or the medicine or nutraceutical for preventing or treating a disease that are most likely to be effective and/or least likely to cause adverse reactions. As previously disclosed, the genome can disclose many conditions. The individual 08 may select from the over 5,000 monogenic, polygenic and multifactorial phenotypes (including but not limited to diseases, disorders, trait, characteristics and pharmacogenomics) in order to enable themselves or health care provider to lower risk of the diseases. Examples of the use of such genetic information can be found in numerous patents, publications, patent applications and include but are not limited to US PreGrant Publications 20090307181, 20090307180, 20090307179, 20090299645, and U.S. Pat. Nos. 8,543,339, 8,367,333, 8,580,501, 8,637,244, 8,697,360, all of which are expressly incorporated herein by reference. The individual 08 may select assessment and/or predicted age range of onset for Alzheimer's or dementia in normal or sporting activity along with genetically tailored preventions that may help lower risk. The individual 08 may select assessment of melanoma risk for help lowering risk of the disease. The individual 08 may select heart attack risk assessment for help lowering risk of the disease. The individual 08 may select osteoarthritis risk assessment for help lowering risk of the conditions. The individual 08 may select heart arrhythmia assessment for help lowering risk of the condition. A parent may choose to have a genome of individual 08, such as a child, assessed for Sudden Infant Death Syndrome risk assessment for insight and/or help about lowering the risk of the event for that individual. The individual 08 may select athletic predisposition assessment for insight and/or help improving physical workouts such as to become more physically fit. The individual 08 may select male pattern baldness risk assessment for information about possible age of onset and/or help lowering the risk of the trait. The individual 08 may select vitamin, supplement and/or weight loss genetic-based optimization for help developing a personalized diet, vitamin, or supplement plan. The individual 08 may select digestive system assessment for help developing an optimum diet. The individual 08 may select lactose intolerance assessment for help developing an optimum diet. The individual 08 may select detoxification assessment for help minimizing the risk of diseases, such as cancer, Alzheimer's Disease and/or Autism Spectrum Disorder, that may be related to detoxification of environmental substances. The individual 08 may select diabetes mellitus type II assessment for information and/or help predicting risk and/or lowering risk of diabetes mellitus type II. The above are representative, non-limiting examples of conditions that can be selected for monitoring.

At step 400, the system compares the personal genome 20 to the reference genome 40.

The system employs the reference genome 40 as a baseline dataset for comparing and interpreting the differences between it and the personal genome 20. The received personal genome 20 is compared to the selected reference genome 40 as is known in the art using such approaches as genetic match maker, likelihood a Variant of Unknown Significance is likely to be associated with a phenotype, American College of Medical Genetics (ACMG) recommended prenatal screening, Variant Call Format (VCF) genome management and browser, VCF Exome management and browser, VCF generator, or others.

At step 500, a sensor 32 corresponding to or related to the selected phenotype is selected. For example, where skin cancer is the selected condition, a MNGF associated with skin cancer is ultraviolet light exposure and an ultraviolet light sensor is a suitable sensor 32. For example, where obesity impact is the chosen phenotype, a MNGF associated with increased or decreased risk of obesity is the amount of activity a person performs during a day an accelerometer and/or sweat meter and/or pulse oximeter are all suitable sensors 32 that measure a MNGF associated with obesity.

A sensor may be any biosensor or other sensor that measures an environmental factor phenotype that is related to a phenotype of interest. For example, a pedometer that measures number of steps taken is related to diabetes mellitus type II because the amount of physical activity a person engages in is an environmental (ie non-genetic) factor that can increase or decrease the individual's risk of diabetes mellitus type II. A sensor may exist at a different location than the individual. For example, a sensor that measures cloud coverage and amount of sunlight can provide information that is related to the phenotype Seasonal Affective Disorder since the amount of sunlight a person is exposed to may contribute, along with the individual's genetic makeup, to the individual's risk of Seasonal Affective Disorder and A sensor that measures cloud coverage and/or sunlight or a sensor that measures GPS coordinates may be related to multiple sclerosis because the amount of sunlight a person is exposed during early in life, as well as the individual's genetic makeup, may be used to predict risk of multiple sclerosis as well as indicate preventive measures such taking vitamin D supplements or relocating to a place with more sun exposure during childhood may also be useful to indicate when preventive treatment should be started or discontinued. A sensor may be used that is in broad geographic proximity.

At step 600, optimum values for the sensor 32 are calculated. The optimum values are calculated and dependent upon the MNGF associated with a selected phenotype. For example, an ultraviolet (UV) sensor selected for skin cancer risk condition may have an upper threshold as a function of intensity, the strength of UV radiation at the moment of measurement, or dose, the total UV energy measured over a period of time. For example, a UV sensor selected for vitamin D deficiency condition may have a lower threshold as a function of intensity, the strength of UV radiation at the moment of measurement, or dose, the total UV energy measured over a period of time. Optionally, the optimum values may be adjusted according to non-genetic factors. For example, the likelihood of skin cancer can increase with tobacco use. Accordingly, the upper threshold may be decreased.

At step 700, the sensor 32 output is monitored 700. The sensor 32 is activated and placed in proximity of the individual. The sensor 32 can be wearable, implanted, or attached to a device in continuous proximity to the individual, such as a smartphone, or the sensor may not be located near the individual and instead may communicate with a device located near the individual such as the individual's smartphone. The sensor 32 output is received and stored by the system.

At step 800, the alerts and reporting are presented. Alerts and reporting are presented based on the selected condition and the received sensor 32 values. The system may present an alert upon a threshold sensor 32 value. For example, where the sensor 32 is a UV sensor, a real-time alert may be presented on the smartphone 18 of the individual 08 notifying him or her to avoid further sun exposure or apply sunscreen. In an alternate example, the system may present a report of UV exposure per day over a period of time for vitamin D synthesis.

In one embodiment of the invention, an individual may provide access to his or her genetic data such as by providing access to one or more genetic data files stored by a cloud provider or by a physical file upload such as via an API. The availability of the genetic data is one possible starting point for the real time personalization. The individual will have access, such as through applications that come pre-installed on a device, through an app store, or other online marketplace for purchasing and/or download apps, to a collection of software applications that utilize some or all of the individual's genetic data during the processing of the application.

Software applications that use data from an individual's genome as an output may then adjust the output, results or conveyance of information to the individual based upon the individual's genetic data and/or information from one or more sensors. The software application may utilize an individual's genotype or phenotype information interpreted from the individual's genome in combination with the results from one or more sensors to personalize the software application to the individual. For example, the software application may be programmed to provide specific information to individuals with a specific phenotype and specific sensor reading. The information may be in the form of a notification to an individual or to a representative of the individual such as a healthcare provider, corporation, government, organization or family member. The individual or a representative of the individual may be notified by the software application of information that is relevant to the individual. This may occur in real time (milliseconds or less) or in near-real time (such as seconds, minutes or hours).

In one embodiment the individual may install a software application on his or her device and be able to view information from the software application that is personalized to him or her.

On one embodiment, the API layer may be always-on-always connected. This means that once a software application has been triggered by the end user or by a sensor described herein, then regular periodic updates, such as pop-up notifications, emails, text messages or other similar alerts may be sent to the user. This provides real-time personalized information to the individual or a representative of the individual.

In one embodiment, the API can be configured to be always connected to dynamic (changing) real-time information. This means if the data from a certain application meets a threshold then it may trigger another software application to start, to alter its functioning or to receive a different input. Thus the platform is able to provide real time analysis of genetic data using either a single software application or interconnected software applications.

### Example 1

### Heart Attack Assessment and Monitoring

At step 100, the individual 08 logs in to a portal and permits it to access his personal genome 20. At step 200, the system receives the FreeMan reference as the reference genome 40. At step 300, diabetes mellitus type II, myocardial infarction, coronary artery disease, and obesity are the selected phenotypes. At step 400, the system compares the personal genome 20 to the reference genome 30 and determines one or more genotypes of an individual. Phenotypic interpretation is then conducted, such as using algorithms to assess carrier status for monogenic phenotypes and algorithms to assess risk of polygenic and multifactorial phenotypes. In this example, phenotypic interpretation finds that the individual is at high risk for all phenotypes. At step 500, the MNGF number of steps per day is chosen and a pedometer is selected as a sensor 32 for providing the individual with specific walking goals each day that will help lower the risk for the phenotypes. At step 600, an optimal number of steps per days is calculated. At step 700, the pedometer output is monitored 700. At step 800, daily reports are presented showing the actual step count versus the optimal step count. The device and/or software application may also provide monetary or non-monetary incentives for the individual to walk more often or for obtaining specific goals.

### Example 2

### Skin Cancer Assessment and Monitoring

At step 100, the individual 08 logs in to a portal and uploads or grants access to his personal genome 20. At step 200, the system receives a reference genome, such as the FreeMan reference or a NCBI reference genome as the reference genome 40. At step 300, melanoma skin cancer is the selected phenotype for monitoring. At step 400, the system compares the personal genome 20 to the reference genome 30 to ascertain the genotypes at the relevant chromosomal coordinates such as by converting a FASTQ or BAM file into a VCF file. The system may alternatively not be required to perform this step and instead may access the already ascertained genotypes at the chromosomal coordinates relevant to the phenotype, such as may be provided in a VCF file. Phenotypes related to melanoma skin cancer risk can be deduced from analysis of the specific genotypic data. These phenotypes may include matching an individual's skin type score, the Fitzpatrick Skin Type, the likelihood of burning, tanning ability, and risk of adverse reaction to the optimal skin care products for that individual. Based on the interpretation, the system determines that individual's skin is at slightly increased relative or absolute risk to burn easy when exposed to UV radiation compared to other individuals (such as individuals of the same population and/or gender). The system may also determine from interpretation of genetic data that the individual is likely some but not many freckles. The system retrieves the weather forecast for the individual's 08 region, including forecasted sun activity. At step 500, a UV sensor 32 is selected. At step 600, the system groups UV contemporaneous exposure values into low risk, normal risk, increased risk, moderate risk, high risk, and very high risk. As the individual's skin is at slightly increased risk of burning when exposed to UV light, the system assigns him as moderate risk and moderate UV exposure value as an upper threshold. At step 700, the UV sensor 32 output is monitored 700. At step 800, at noon the individual receives an alert to apply high value SPF to his skin.

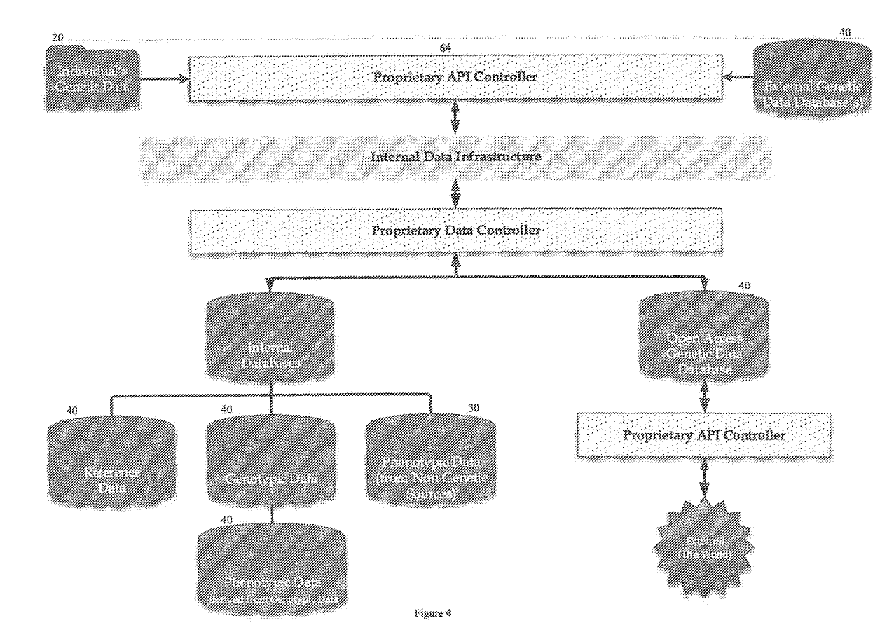

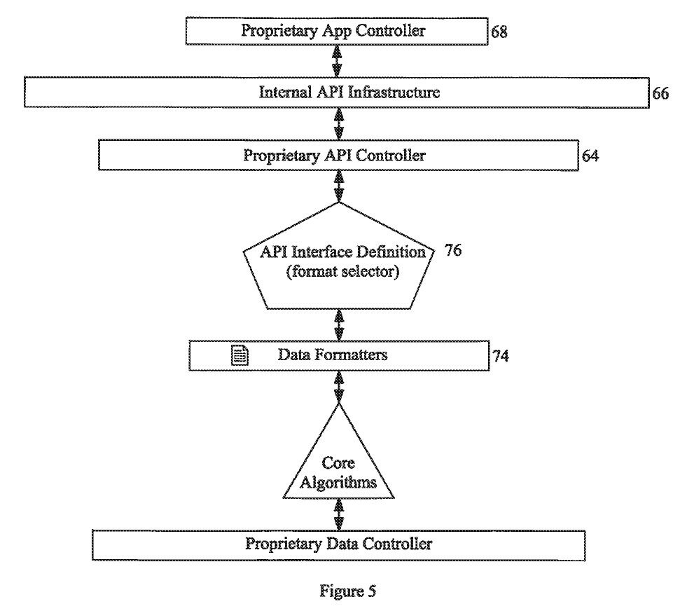

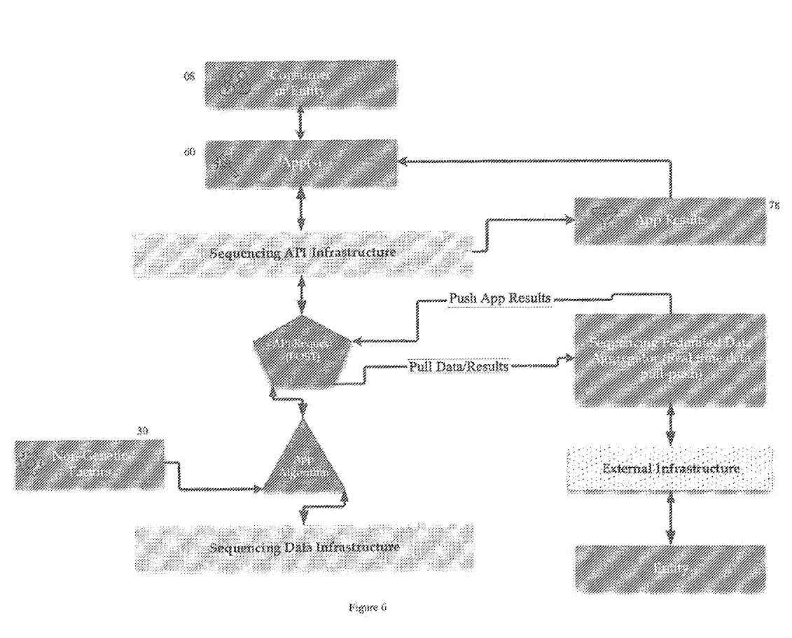

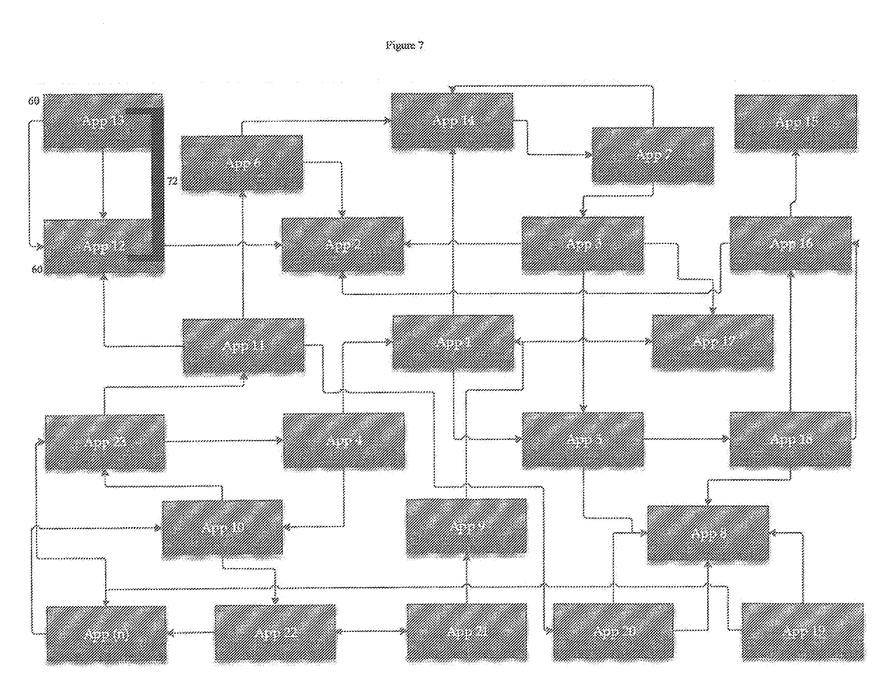

FIGS. 4-7 illustrate representative application infrastructure of the current invention. An application 60 is a module which performs the tasks for a given condition, namely receiving 100 200 and comparing 400 genomes 20 40 for an assigned condition 300, monitoring sensor output 700 and alerting/reporting in response to the sensor output 800. The application infrastructures facilitate monitoring application 60 and system usage 900.

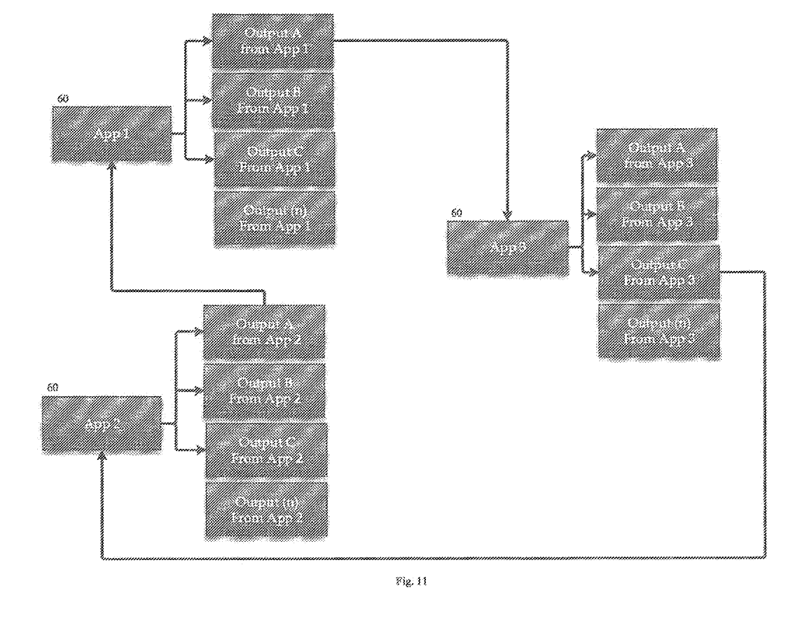

The application infrastructure facilitates the monitoring and management of all application related activities such as maintaining a database of applications 60, where applications 60 may be categorized. The application infrastructure acts as a secure wrapper between the user interface and its own module, the application controller 68. The application controller 68 functions to make applications 60 available, execute them and display results. The application infrastructure provides the rules and framework for applications 60 to communicate with the database servers and execute the methods of the invention. The application controller 68 is a module which manages of applications 60. It also interfaces with other applications 60 to provide application sequencing. Application sequencing means that any application which belongs to the sequencing application ecosystem can make its analysis available to other applications 60. This means that when the execution of one application is completed the results of the first application can be piped into another application and so on as shown in FIG. 11. Thus the application controller 68 can create a large cascade of applications 60 which are executing back-to-back with each application producing the results it was programmed for as well as communicating with APIs with other end-points. The application controller 68 supports calling API using REST, SOAP, JSON, or other similar protocols.

The application controller 68 monitors application 60 usage as well as application 60 to application 60 usage. Accordingly, application 60 usage can be monitored so that its usage can be measured by click/byte/CPU cycles, inter-application calls can be measured by calls/byte/CPU cycles. The measurements can be monitored at the application 60 level, inter-application level, application groups 72, or by other categorization.

In an embodiment, different applications 60 may be affiliated with or sponsored by third parties that have an interest in the data obtained by the application 60 or the users who use such an application. As such, the third parties may develop or supplement development of an application 60 for a particular purpose. Alternatively, once an application 60 is developed, a third party may take interest and pay the open system manager for the rights to advertise within the application 60 or to the application 60 users or purchasers. As such, the third party may require the user to opt-in to receipt of advertising, offers, coupons, rebates, educational information, offers to participate in research studies and the like of materials related to the application 60 or of interest to the third party, in exchange for downloading the application 60, for downloading the application 60 for free or at a reduced price and/or for receiving a monetary or non-monetary incentive including but not limited to cash payments, reward points, and/or coupons or other discounts for products or services. As such, in an embodiment, once a user runs an application 60, the results may be sent not only to the user or open system manager, but to the third party who may then provide information to the user based on the obtained results. The application 60 is run by the user and the results transferred to the third party, among others as appropriate. The third party may then provide to the user via email, mail, text messaging, instant messaging, push notifications, within the application 60 or other methods as known in the art, information related to the results of the app, such as, but not limited to educational information, coupons, rebates, social media sites, sweepstakes and/or links to a web-site. The web site may provide educational information, coupons, rebates and/or may be a retail site to allow for the purchase of materials relevant to the application 60 and/or search results. For instance, an application 60 to predict if a person is at risk of male-pattern baldness may be run and results provide the likelihood of affliction and/or information on what they can do to prevent it. The application 60 may also provide a coupon to a specific treatment for male-pattern baldness. Alternatively, the application 60 may provide the names and contact information of healthcare professionals in the area that provide treatments that prevent or slow male-pattern baldness. Another application 60 may predict a person's risk for skin cancer and identify the best suntan lotion and/or skin care product based on the person's biological data, such as his or her genetic information. In another alternative, a third party may provide coupons for the identified products.

The system also provides for a user to link to a retail site through content received from a third party related to the application 60 used. In an embodiment, if a user links to a third party retail site directly or indirectly resulting from content received from the third party and consummates a transaction, the open system manager may receive a fee. As such, the system allows for marketing, advertising and/or sales based on the biological information of an individual.

Data available on the system may also be used via an application 60 to personalize marketing and other business processes of a company. For example, in this embodiment genetic or other biological data about whether an application 60 user's actual or predicted visual acuity, such as if the user is more likely to be near sighted or far sighted, may be assessable to a marketing department to create advertisements and/or coupons that adjust in size on the electronic device's display based upon the user's predicted visual acuity.

The size-adjusted advertisements and/or coupons will therefore be genetically tailored to the user. Likewise, applications 60 that determine a user's short-term and long-term memory level or genetic and/or other biological data that may be used to predict an application 60 user's memory may be used by companies' in-order to provide marketing materials at time-intervals that are personalized to each user. For example, users with better short-term memory or that are predicted to have better short-term memory may be sent marketing material, such as advertisements, less often than users that have or are predicted to have worse short-term memory.

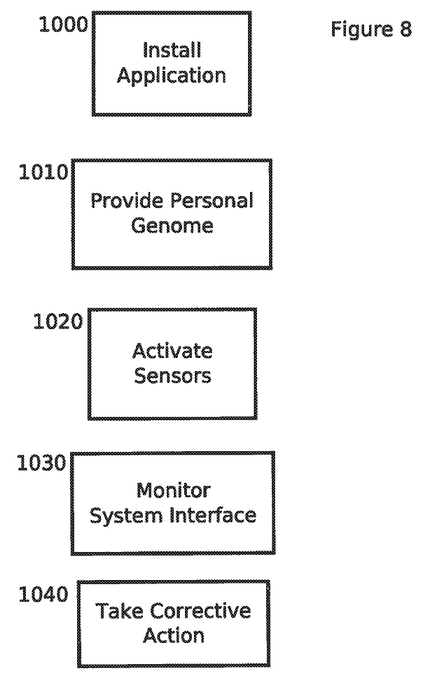

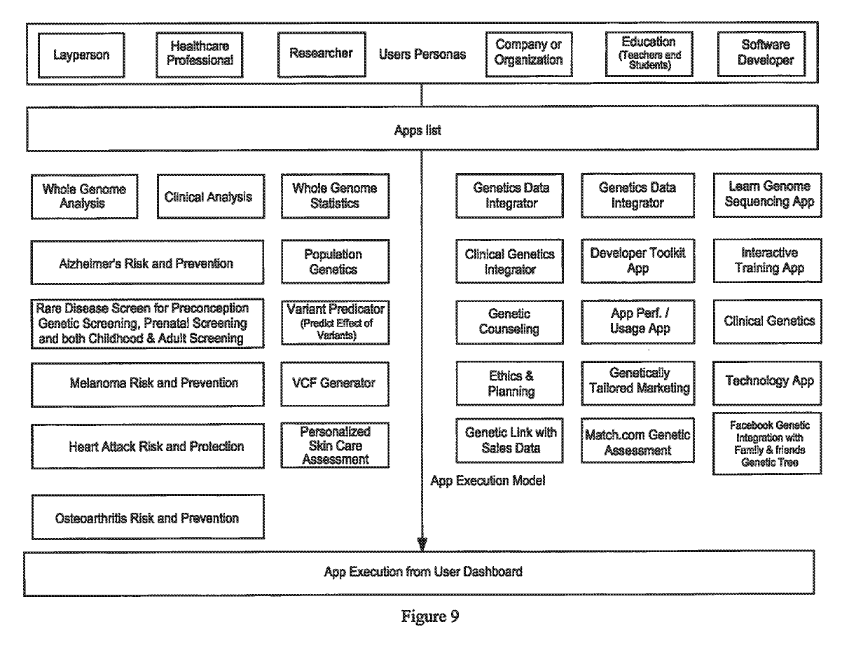

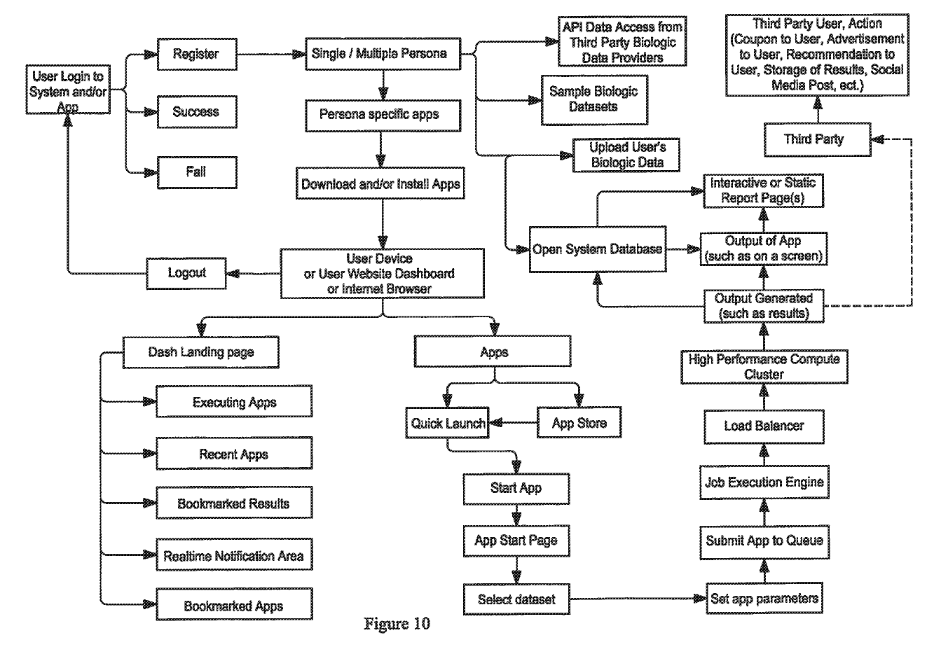

FIGS. 8-10 illustrate an end user's usage of the system. At step 1000, a user downloads an application 60 to a smartphone 18. The user may be an individual whose biological information is to be analyzed or may be run by an authorized party such as a service provider, caregiver, parent, or the like. Other users that may utilize the open system described herein include laypeople, healthcare professionals, researchers, organizations, companies, educational institutions, governments, and software developers. The term ‘downloaded’ may refer to downloading the application 60 software, downloading part of the application 60 software code, installing the application 60 on a device or on other software such as an internet browser or operating system, downloading and/or installing the application 60 as part of other applications 60 or software, and/or installing or adding the application 60 to a website or websites without any software code being placed on the user's electronic device such as his or her phone, computer, tablet device and/or server. In some instances the user purchases the applications. As such, the system also includes software for handling purchases over the Internet, as is known in the art. The user may be presented with a list of applications 60 to select.

Once the user has access to the application 60, they can execute it to obtain results. The personal genome is provided 1010 and attaches sensors, as necessary 1020. The user monitors the system interface for results 1030. The output and/or results of the application 60 may be interactive meaning that the user may be able to change parameters of the application 60 that then change the output and/or results conveyed by the application 60 or the output and/or results may be static meaning the output and/or results of an application 60 do not change. The output and/or results of an application 60 may change if the biological data that is used as input(s) into the application 60 changes. In some embodiments, the results are distributed to the user, a service provider or care-giver, a third party, which may be a third party that sponsored the downloaded application 60 or has an agreement and/or contract with the third party that sponsored the downloaded app, and/or to the open system database. In some instances, the system interface may present steps for corrective action to the user, such as applying sunscreen or exercising 1040.

While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the present invention.

We claim:

1. A computer implemented method of analyzing biological data comprising:
a. a computer with memory having a reference genome database, operable as a baseline dataset, comprising biological data of part of all of the genome of a subpopulation and essentially free of genetic variations know to cause dominant monogenic, polygenic, or multifactorial diseases;
b. a computer with memory having a personal genome comprising biological data of part or all of said individual; and
c. a computer configured to compare the sequence of said personal genome, or part thereof, with the sequence of said reference genome for differences in a selected condition.

2. The method of claim 1, wherein said biological data is selected from the group consisting of genomic sequence information, proteomic data, exome data, methylation data, mRNA expression data, metabolome data, microbiome data, mitochondrial sequence data and karyotype data.

3. The method of claim 1 further comprising selecting a sensor operable to directly or indirectly measure conditions expressed by or responsive to the selected condition.

4. The method of claim 3 further comprising selecting a threshold value for said measured condition.

5. The method of claim 3 wherein said value varies as a function of the comparison said genomic comparison.

6. The method of claim 4 further comprising monitoring said sensor output value.

7. The method of claim 4 further comprising presenting an alert on an out of bound threshold condition.

8. The method of claims 4 further comprising presenting a comparison of the periodic sensor output with said threshold value.

9. The method of claim 1 wherein said selected condition is selected from known monogenic diseases.

10. The method of claim 1 wherein said selected condition is selected from: likelihood of developing skin cancer, melanoma risk, heart attack risk, osteoarthritis risk, cardiac arrhythmias risk, athletic performance predisposition, vitamin and supplement uptake, weight gain predisposition, and deficient detoxification pathways.

11. The method of claim 1 wherein said selected condition is skin cancer and said sensor is an ultraviolet sensor.

12. The method of claim 1 wherein said selected condition is vitamin D uptake and said sensor is an ultraviolet sensor.

13. The method of claim 1 wherein said selected condition is heart attack risk or cardiac arrhythmias risk and said sensor is a heart rate sensor.

14. The method of claim 1 wherein said selected condition is osteoarthritis risk and said sensor is an accelerometer.

15. The method of claim 1 wherein said selected condition is athletic performance predisposition or weight gain predisposition and said sensor is an accelerometer.

16. A method of analyzing biological data comprising:
a. providing a system comprising:
i. a computer comprising memory comprising a database comprising biological data from a plurality of subjects said biological data obtained from at least a first and second source; and
ii. a plurality of software applications for performing a plurality of different analyses of biological data;
b. selling at least a first of said applications capable of performing at least a first analysis of biological data to a consumer;
c. running said first application to perform at least a first analysis of biological data.

17. The method according to claim 1, wherein said biological data is selected from the group consisting of genomic sequence information, proteomic data, exome data, methylation data, mRNA expression data, metabolome data, microbiome data, mitochondrial sequence data and karyotype data.

18. The method according to claim 16, wherein said software applications compare a first set of biological information to the biological data from at least a subpopulation of said plurality of subjects.

19. A method of selling advertising comprising:
a. providing a system comprising:
i. a first computer comprising memory comprising a database comprising biological data from a plurality of subjects said biological data obtained from at least a first and second source; and
ii. a plurality of software applications for performing a plurality of different analyses of biological data;
b. performing an analysis by at least one of said applications of an individual's biological data; and
c. selling advertising to said advertiser based on the results of said analysis.

20. A non-transitory computer program product for analysis of genetic data, the computer program product being embodied in a computer readable storage medium and comprising computer instructions for:
a. storing a plurality of software applications for performing a plurality of different analyses of genetic data;
b. providing access to a user to at least a first of said software applications.
c. receiving input of genetic data;
d. performing an analysis of said input genetic data using the software applications;
e. providing an output of results of said analysis to said user or third party or both, wherein said results are analyzed in conjunction with sensor input data to provide real-time personalized results.
